(19) United States
(12) Patent Application Publication
(10) Pub. No.: US 2026/0029976 A1
(43) Pub. Date: Jan. 29, 2026

(54) METHOD FOR DISPLAYING CONTENT AND ELECTRONIC DEVICE SUPPORTING THE SAME

(71) Applicant: SAMSUNG ELECTRONICS CO., LTD., Suwon-si (KR)

(72) Inventors: Sanghun SO, Suwon-si (KR); Suyoun KIM, Suwon-si (KR); Hyeseong OH, Suwon-si (KR); Youngha PARK, Suwon-si (KR)

(73) Assignee: SAMSUNG ELECTRONICS CO., LTD., Suwon-si (KR)

(21) Appl. No.: 19/281,028

(22) Filed: Jul. 25, 2025

Related U.S. Application Data
(63) Continuation of application No. PCT/KR2025/010805, filed on Jul. 22, 2025.

(30) Foreign Application Priority Data
Jul. 26, 2024 (KR) 10-2024-0099606
Oct. 14, 2024 (KR) 10-2024-0139786

(51) Int. Cl. G06F 3/14; G06F 3/04817; G06F 3/04845; G06T 5/40; G06T 5/50; G06T 7/90

(52) U.S. Cl. CPC G06F 3/14; G06F 3/04817; G06F 3/04845; G06T 5/40; G06T 5/50; G06T 7/90; G06T 2207/10024; G06T 2207/20221

(57) ABSTRACT

An electronic device includes a display; memory storing instructions; and at least one processor comprising a processing circuit, wherein the instructions, when executed by the at least one processor individually or collectively, cause the electronic device to: determine a content to be displayed on the display and a first area allocated to the content, determine a second area included in the first area, determine a dominant color in a fourth area including a third area corresponding to the content, determine an amount of transparency of the dominant color, determine a section including the amount of transparency among a plurality of sections distinguished by a plurality of reference values related to the amount of transparency, determine a background image to be applied to the second area according to the determined section, combine the content and the background image and display the combined content and background image on the display.

### CROSS-REFERENCE TO RELATED APPLICATIONS

This application is a continuation of PCT International Application No. PCT/KR2025/010805, which was filed on Jul. 22, 2025, and claims priority to Korean Patent Application No. 10-2024-0139786, filed on Oct. 14, 2024, and claims priority to Korean Patent Application No. 10-2024-0099606, filed on Jul. 26, 2024, in the Korean Intellectual Property Office, the disclosures of each of which are incorporated by reference herein their entirety.

### BACKGROUND

### 1. Field

The disclosure to a method for displaying a content and an electronic device supporting the same.

### 2. Description of Related Art

An electronic device (e.g., a smartphone, a tablet, a desktop, or a virtual studio technology (VST) device) may include a display (or a display module). The electronic device may display various types of digital content (e.g., text, an image, an icon, a widget, a video, a digital object, or a user interface (UI)) through the display. Methods for filling empty margins of the digital content with a background may include: 1) a semi-transparent background, 2) a blurred background, and 3) a dominant color extraction background. While these methods may apply a background to the content, these methods do not appropriately fill a background according to the composition and characteristics of the content.

### SUMMARY

According to an aspect of the disclosure, an electronic device, includes: a display; memory storing instructions; and at least one processor comprising a processing circuit, wherein the instructions, when executed by the at least one processor individually or collectively, cause the electronic device to: determine a content to be displayed on the display and a first area allocated to the content, determine a second area included in the first area, determine a dominant color in a fourth area including a third area corresponding to the content, determine an amount of transparency of the dominant color, determine a section including the amount of transparency among a plurality of sections distinguished by a plurality of reference values related to the amount of transparency, determine a background image to be applied to the second area according to the determined section, combine the content and the background image and display the combined content and background image on the display.

According to an aspect of the disclosure, a method for displaying a content performed on an electronic device, including determining the content to be displayed on a display of the electronic device and a first area allocated to the content; determining a second area included in the first area; determining a dominant color in a fourth area including a third area corresponding to the content; determining an amount of transparency of the dominant color; determining a section including the amount of transparency among a plurality of sections distinguished by a plurality of reference values related to the amount of transparency; determining a background image to be applied to the second area according to the determined section; and combining the content and the background image and displaying the combined content and background image on the display.

According to an aspect of the disclosure, a non-transitory computer readable medium having instructions stored therein, which when executed by a processor cause the processor to execute a method for displaying a content performed on an electronic device, including determining the content to be displayed on a display of the electronic device and a first area allocated to the content; determining a second area included in the first area; determining a dominant color in a fourth area including a third area corresponding to the content; determining an amount of transparency of the dominant color; determining a section including the amount of transparency among a plurality of sections distinguished by a plurality of reference values related to the amount of transparency; determining a background image to be applied to the second area according to the determined section; and combining the content and the background image and displaying the combined content and background image on the display.

### BRIEF DESCRIPTION OF DRAWINGS

FIG. 1 is a block diagram illustrating an electronic device in a network environment according to various embodiments.

FIG. 2 is a flowchart illustrating a content display method according to one or more embodiments.

FIG. 3 illustrates display of a background image according to an embodiment.

FIG. 4A illustrates an area for extracting a dominant color according to an embodiment.

FIG. 4B illustrates a method for extracting a dominant color using a histogram according to an embodiment.

FIG. 5 illustrates a plurality of sections according to the transparency of a dominant color according to an embodiment.

FIG. 6A illustrates layer combining of a content in a first section according to an embodiment.

FIG. 6B is an example diagram illustrating display of a background image in the first section according to an embodiment.

FIG. 7A illustrates layer combining of a content in a second section according to an embodiment.

FIG. 7B is an example diagram illustrating display of a background image in the second section according to an embodiment.

FIG. 8A illustrates layer combining of a content in a third section according to an embodiment.

FIG. 8B is an example diagram illustrating display of a background image in the third section according to an embodiment.

FIG. 9 illustrates a change in a background area according to a change in a content allocation area according to an embodiment.

FIG. 10 is an example diagram illustrating an inverted background image according to an embodiment.

With respect to the description of the drawings, the same or similar reference signs may be used for the same or similar elements.

### DETAILED DESCRIPTION

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure. With regard to the description of the drawings, similar reference numerals may be used to refer to similar elements.

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and B,” “at least one of A or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

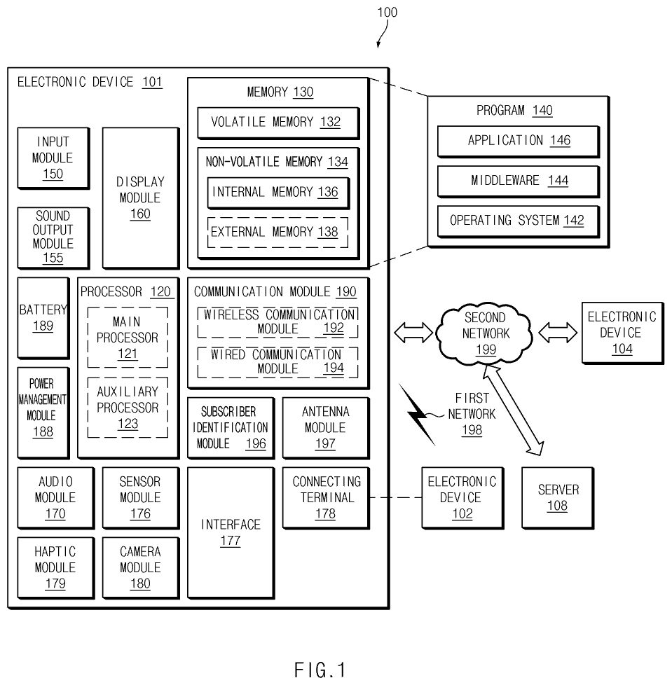

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one or more embodiments, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wired) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

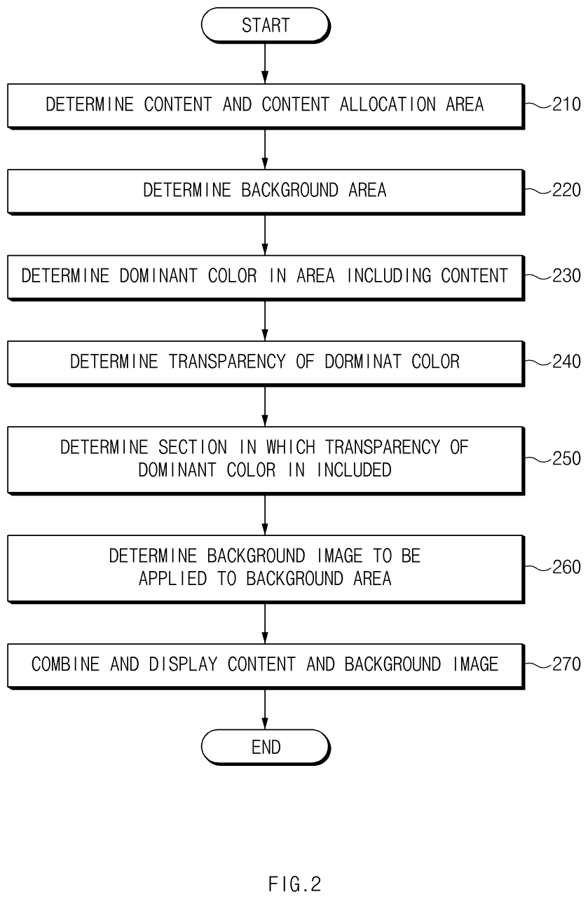

FIG. 2 is a flowchart illustrating a content display method according to an embodiment.

Referring to FIGS. 1 and 2, in operation 210, the processor 120 may determine a content (a digital content, digital object) to be displayed on the display and a first area allocated to the content (hereinafter, a content allocation area). For example, the content to be displayed on the display may be a widget, an icon, or a digital object of an application. In one or more examples, the content may be an interface for an audio player for outputting audio content or a video player for outputting video content. In the following, a case where the content to be displayed is a widget of the application will be mainly discussed. However, the embodiments are applicable to any suitable type of content known to one of ordinary skill in the art.

According to an embodiment, the processor 120 may divide the display into a plurality of grids and display a content according to the arrangement of the plurality of grids. A content allocation area for each content may be determined by grid units set on the display. For example, the content allocation area may be identical to a grid area occupied by the content, or may be a partially reduced area of the grid area occupied by the content. According to an embodiment, the content allocation area may be variously determined as grid areas such as 1×1, 2×1, 2×2, 3×3, 4×1, 4×2, 4×3, and 4×4, depending on a value required by the application.

For example, when the content corresponds to an icon, the icon may be disposed within a 1×1 grid. In this case, the content allocation area may be inside a grid of 1×1. For another example, when the content indicates a widget, one of several options supported by the application may be selected by a user input. When the application supports sizes of 4×1 and 4×2, and the size of 4×1 is selected by a user input, a widget may be disposed inside grids of 4×1. In this case, the content allocation area may be inside the grids of 4×1.

According to an embodiment, the content allocation area may be determined in pixel units. For example, the content allocation area may be determined in various ways, such as (100 pixels×100 pixels), (200 pixels×100 pixels), or (300 pixels×300 pixels), depending on values required by the application.

In operation 220, the processor 120 may determine a second area (hereinafter, a background area) included in the content allocation area. The background area may be smaller than or equal to the content allocation area.

According to an embodiment, the size of the background area may be determined in advance according to the size of the content allocation area. The background area may have a size corresponding to the size of the content allocation area. For example, when a first widget of a first application has a content allocation area of 4×1 and a second widget of a second application has a content allocation area of 4×1, the background area of the first widget and the background area of the second widget may have the same size.

According to an embodiment, the background area may include a third area (hereinafter, a content area) occupied by the content. The background area may be larger than or equal to the content area.

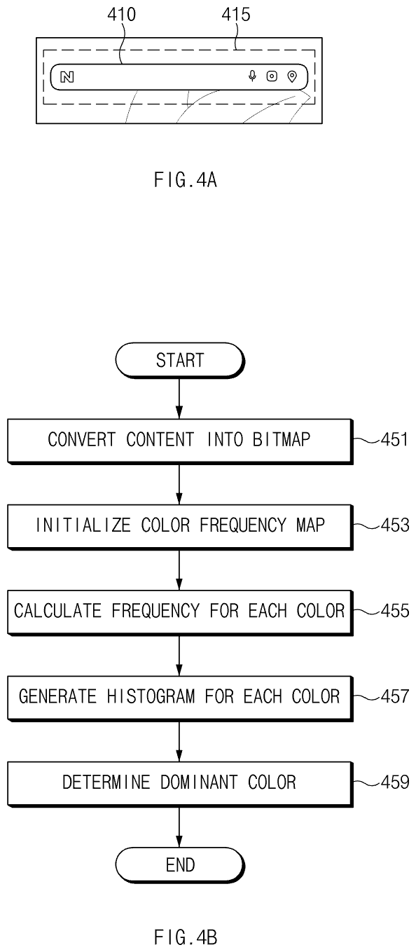

In operation 230, the processor 120 may determine a dominant color (or a representative color) in a fourth area (hereinafter, a dominant color extraction area) including the content area. According to an embodiment, the dominant color extraction area may be larger than or equal to the content area. In this case, the dominant color extraction area may include a portion of the background area. In one or more examples, the dominant color extraction area may be smaller than or equal to the background area (see FIG. 4A).

According to an embodiment, the processor 120 may include at least a portion of the content area in the dominant color extraction area. For example, the processor 120 may include an area sampled from at least a portion of the center or periphery of the content area in the dominant color extraction area.

For example, the processor 120 may convert the content area into a digital image (bitmap image) and check a frequency for each color. The processor 120 may determine the color with a highest frequency as the dominant color. Alternatively, the processor 120 may determine a color with a second most frequency as the dominant color when the color with the highest frequency is transparent (e.g., has an amount of transparency less than or equal to a transparency threshold), or may determine the dominant color by reflecting a preset weight according to the frequencies. Additional information regarding determination of the dominant color may be provided through the drawings below.

In operation 240, the processor 120 may determine the transparency of the dominant color. The processor 120 may check a value representing the transparency included in a color value. For example, the processor 120 may check an alpha value (or an alpha channel) indicating the degree of opacity among the color values of RGBA (red, green, blue, alpha). The alpha value may have a value from 0 (completely transparent) to 255 (completely opaque). In one or more examples, the alpha value may correspond to an amount of transparency of a color.

In operation 250, the processor 120 may determine a section, among a plurality of sections related to transparency, in which transparency of the dominant color is included. The plurality of sections may be divided by a plurality of reference values related to transparency.

According to an embodiment, the processor 120 may set a first reference value related to transparency and a second reference value greater than the first reference value as a plurality of reference values. The processor 120 may divide the sections into a first section having an alpha value smaller than the first reference value, a second section having an alpha value greater than the first reference value and smaller than the second reference value, and a third section having an alpha value greater than the second reference value. The processor 120 may determine which section the alpha value of the extracted dominant color belongs to among the first to third sections.

In operation 260, the processor 120 may determine a background image to be applied to the background area based on the section including the dominant color. For example, in a first section where the transparency of the dominant color is relatively high (e.g., a section with a transparency of 90% or more, or a section with an alpha value of 26 or less), the processor 120 may determine a blur image as the background image. In another example, an opaque image generated using the blur image and the dominant color in a second section corresponding to an intermediate level of transparency (e.g., a section of transparency from less than 90% to 10% or more, or a section of an alpha value greater than 26 and less than or equal to 229) may be combined to determine the background image. For still another example, in a third section (e.g., a section with transparency less than 10%, or a section with an alpha value greater than 229) where the transparency of the dominant color is relatively low (opacity is high), the processor 120 may determine an opaque image generated using the dominant color as the background image.

In operation 270, the processor 120 may combine and display the content and a background image on the display. The processor 120 may display the content in a first layer and the background image in a second layer. The first layer and the second layer may be different layers from a layer on which the background image of the home screen is displayed.

When the background image in which the transparency of the dominant color of the content is reflected is displayed in the background area, the visibility of the content may be significantly improved. In addition, by setting the background area corresponding to the size of the widget to be consistent, the home screen may be displayed more consistently.

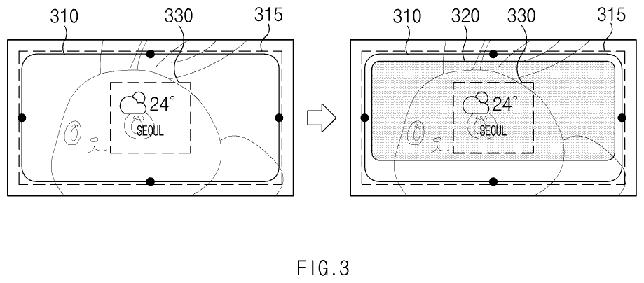

FIG. 3 illustrates display of a background image according to an embodiment.

Referring to FIG. 3, the processor 120 may display a content (e.g., a weather widget) on the display. The processor 120 may determine the content to be displayed automatically or by a user input. In the case of automatic setting, the processor 120 may determine the size of the widget (a size of a content allocation area) by default. In case of setting by the user input, the processor 120 may determine the size of the widget (a size of the content allocation area) to the size selected by the user input. In one or more examples, the automatic setting may determine a time when the widget is displayed (e.g., 8:00 am in the morning) or a location of the user's device when the widget is displayed (e.g., user's device is located a predetermined distance from a home distance).

According to an embodiment, the processor 120 may set a content allocation area 310 according to the size of the widget. The content allocation area 310 may be the same as a grid area 315 allocated to the content, or may be a partially reduced area of the grid area 315 allocated to the content. The grid area 315 may be composed of a plurality of quadrilateral areas in which a content may be displayed on the display. The number of quadrilateral areas in which each widget of an application may be disposed is specified, and the widget of the application may be disposed within the specified quadrilateral areas. For example, for the widget of the weather application, the processor 120 may set the content allocation area 310 corresponding to a grid size of 1×1, 2×2, or 4×2.

According to an embodiment, the processor 120 may determine a background area 320 corresponding to the content allocation area 310. The background area 320 may be included in the content allocation area 310, and may be a partially reduced area of the content allocation area 310.

According to an embodiment, the background area 320 may have a preset size corresponding to the size of the content allocation area 310. For example, when a first widget of a first application has a content allocation area of 4×1 and a second widget of a second application has a content allocation area of 4×1, the background area of the first widget and the background area of the second widget may have the same size.

According to an embodiment, the background area 320 may include a content area 330 occupied by the content. The background area 320 may be greater than the content area 330.

According to an embodiment, the processor 120 may reflect a dominant color extraction and transparency to dynamically change the background image of the background area 320 depending on various conditions and situations. Additional information regarding the display of the background image in the background area 320 may be provided through the drawings below.

FIG. 4A illustrates an area for extracting a dominant color according to an embodiment.

Referring to FIG. 4A, the processor 120 may determine a content area 410. For example, the content area 410 may be an area that contains text or images included in a widget. The content area 410 may be preset at a time point of creating an application related to the widget and determined by information included in a configuration file of the application. For example, the content area 410 may be an area set by a manufacturer or a producer who has created the application. However, as understood by one of ordinary skill in the art, the embodiments are not limited to these configurations. For example, the content area 410 may be dynamically determined at a time of execution of the widget.

According to an embodiment, the processor 120 may extract a dominant color (or a representative color) from the content area 410. Then, the processor 120 may display a background image of the content area 410 corresponding to the transparency of the dominant color (or a representative color).

According to an embodiment, the processor 120 may include the content area 410 and extract the dominant color from a partially extended area (dominant color extraction area) 415 in the content area 410. The processor 120 may extract the dominant color based on the frequencies of colors extracted from the content area 410 and an area extended from the content area 410 (e.g., area bordering the content area). The dominant color extraction area 415 may be the same as the background area or may be an area smaller than the background area. Then, the processor 120 may display the background image of the content area 330 corresponding to the transparency of the dominant color (or a representative color).

FIG. 4B illustrates a method for extracting a dominant color using a histogram according to an embodiment.

The processor 120 may extract the dominant color of the content using various algorithms. The processor 120 may determine an extraction algorithm by converting the content into an image (bitmap) and then reflecting factors such as the composition, performance, and accuracy of the content.

For example, the processor 120 may extract the dominant color of the content using a method such as K-Means clustering or a Median Cut algorithm. The K-Means clustering may be a method for classifying colors of an image into K clusters and selecting the center of each cluster as a representative color. In one or more examples, the K-means clustering may be implemented using machine learning for unsupervised data grouping. The K-means clustering may iteratively assign data points to clusters based on their proximity to cluster centroids to minimize a distance between data points and their assigned cluster centers. The Median Cut algorithm may be a method for repeatedly dividing a color space in half to find a representative color. In one or more examples, the median cut algorithm may sort data of an arbitrary number of dimensions into series of sets by cursively cutting each set of data at the median point along the longest dimension.

For another example, the processor 120 may extract a dominant color of the content using histogram analysis. The processor 120 may determine a dominant color through histogram analysis of the following operations 451 to 459. Operations 451 to 459 may be a specific process for implementing operation 230 in FIG. 2. FIG. 4B is an example and embodiments are not limited thereto.

Referring to FIGS. 1 and 4B, in operation 451, the processor 120 may convert a content into a bitmap image. The processor 120 may convert a representative image or a specific image of the content into a bitmap image. The processor 120 may generate a bitmap image corresponding to the content area or a bitmap image corresponding to the dominant color extraction area (see FIG. 4A) that is greater than the content area. Operation 451 may be an operation for preparing histogram analysis.

In operation 453, the processor 120 may initialize a color frequency map. The processor 120 may initialize previous data and prepare to newly store data related to the content to be displayed. When there is no need to initialize the color frequency map, operation 453 may be omitted.

In operation 455, the processor 120 may calculate the frequency for each color in the bitmap image. For example, the processor 120 may sequentially check the color value of each pixel in a specified direction. Until color checking for all pixels is complete, the processor 120 may increase the frequency of the checked color values.

In operation 457, the processor 120 may generate a histogram for each color based on the checked color values. For example, the processor 120 may generate a histogram graph with the X-axis as a color value and the Y-axis as a frequency.

In operation 459, the processor 120 may determine a dominant color of the content based on the generated histogram. For example, the processor 120 may determine a color with the highest frequency as the dominant color of the content. For another example, when the color with the highest frequency is transparent and the color with the second highest frequency is opaque, the processor 120 may determine the color with the second highest frequency as the dominant color, or may apply weights in a preset manner to determine the dominant color of the content.

For example, when the first color with the highest frequency is transparent, the processor 120 may reflect a preset weight (e.g., twice) in the color with the second highest frequency. When the frequency of the first color (transparent color) is high after the weight is reflected in the second color, the processor 120 may determine the first color (transparent color) as the dominant color. Alternatively, when the weight is reflected in the second color so that the frequency of the second color becomes higher than the frequency of the first color, the processor 120 may determine the second color as the dominant color.

According to an embodiment, the processor 120 may not perform operations 451 to 459 when the dominant color related to the content is transmitted from the application in advance or has a previously acquired history.

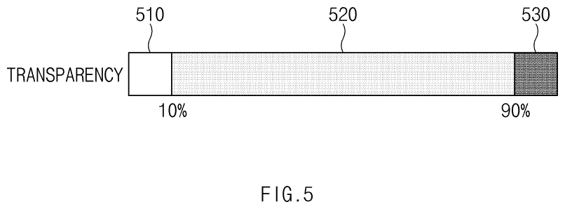

FIG. 5 illustrates a plurality of sections according to the transparency of a dominant color according to an embodiment. FIG. 5 is an example and embodiments are not limited thereto.

Referring to FIG. 5, the processor 120 may check the transparency of a dominant color extracted from the content. For example, the processor 120 may check an alpha value (or an alpha channel) representing opacity among the RGBA (Red, Green, Blue, Alpha) of the dominant color. The alpha value may have a value from 0 (completely transparent) to 255 (completely opaque).

According to an embodiment, the processor 120 may set a plurality of sections distinguished by a plurality of reference values related to the transparency. For example, the processor 120 may distinguish sections into a first section 510, a second section 520, and a third section 530 based on the alpha value.

According to an embodiment, the first section 510 may be a section having a transparency of 10% or less (e.g., the alpha value is 26 or less) of the total (e.g., the maximum alpha value of 255). When the dominant color is the first section 510, it may be indicated that the dominant color is a nearly transparent color.

According to an embodiment, the second section 520 may be a section in which the transparency is greater than 10% (e.g., greater than alpha value of 26) of the total (e.g., the maximum alpha value of 255) and less than or equal to 90% (e.g., less than or equal to alpha value of 229) of the total (e.g., the maximum alpha value of 255). When the dominant color is the second section 520, it may be indicated that the dominant color is a semi-transparent color.

According to an embodiment, the third section 530 may be a section in which the transparency exceeds 90% (e.g., the alpha value exceeds 229) of the total (e.g., the maximum alpha value of 255). When the dominant color is the third section 530, it may be indicated that the dominant color is a nearly opaque color.

The plurality of reference values in FIG. 5 are examples and embodiments are not limited thereto. For example, a ratio or numerical value of the plurality of reference values in FIG. 5 may be adjusted. For example, the alpha value may have a value from 0 (completely transparent) to 511 (completely opaque). Alternatively, for example, the ratio of the plurality of reference values may be set to 20% and 80%.

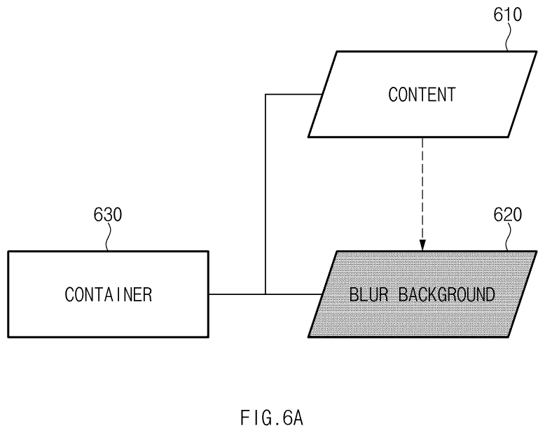

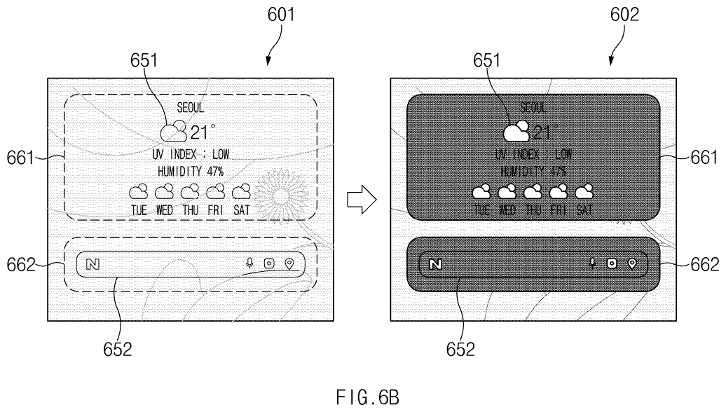

According to an embodiment, the processor 120 may determine a section that includes the alpha value of the dominant color. The processor 120 may set a different background image of the content displayed in the background area of the content for each section. Additional information regarding the application of the background image in each section may be provided through FIGS. 6A to 8B below.

FIG. 6A illustrates layer combining of a content in the first section according to an embodiment. FIG. 6B is an example diagram illustrating display of a background image in the first section according to an embodiment.

Referring to FIGS. 1 and 6A, the processor 120 may extract a dominant color from a content area or a dominant color extraction area. The processor 120 may check an alpha value indicating the transparency of the dominant color. The processor 120 may compare the alpha value of the dominant color with a plurality of reference values. For example, when the alpha value of the dominant color is less than or equal to a first value (e.g., the alpha value of 26), the processor 120 may determine the dominant color as the first section.

According to an embodiment, in the first section with relatively high transparency, the processor 120 may determine a blur image as a background image. The processor 120 may combine a content layer 610 including data of the content and a background layer 620 including the blur image and store them in a container 630. The container 630 may be a buffer that stores output data related to the content. The output data stored in the container 630 may be additionally overlapped on the background image of the home screen and then displayed. In one or more examples, the blur image may be obtained applying a blur effect to an existing image. The blur effect may be a Gaussian blur that applies a soft overall blur, a radial blur that creates a blur effect that radiates from a central point, a motion blur that simulates an effect of movement, or a brush blur in which one or more specific areas of the existing image are blurred.

According to an embodiment, in the first section, the processor 120 may determine a separate opaque image as the background image. In the first section where the transparency of the dominant color is high, the processor 120 may use a separate opaque image to make the content and the background area more visible. For example, the separate opaque image may be an image that uses the background image of the home screen, or an image that uses colors that are inverted from some of the colors contained in the content.

Referring to FIGS. 1 and 6B, the processor 120 may display a first content 651 and a second content 652 on the display. The processor 120 may display the first content 651 and the second content 652 by automatic setting of the electronic device or by a user input. The processor 120 may set a first background area 661 corresponding to the first content 651 and a second background area 662 corresponding to the second content 652.

For example, the first content 651 may be a widget of a weather application. When the first content 651 has a grid size of 4×2, the first background area 661 may be the same as a grid area of 4×2 or may be a partially reduced area of the grid area of 4×2. The first background area 661 may be an area that is enlarged compared to the area occupied by the first content 651.

For example, the second content 652 may be a widget of a search application. When the second content 652 has a grid size of 4×1, the second background area 662 may be the same as a grid area of 4×1 or may be a partially reduced area compared to the grid area of 4×1. The second background area 662 may be an area that is partially enlarged compared to the area occupied by the second content 652.

According to an embodiment, most of each of the first content 651 and the second content 652 may be transparent. In this case, the transparent color is determined as the dominant color, and the transparency of the dominant color may be determined as the first section. The processor 120 may determine a blur image as a background image of the content and display the blur image in background areas 661 and 662.

By comparing a first state 601 before the background image is applied to the background areas 661 and 662 and a second state 602 in which the background image is applied to the background areas 661 and 662, the visibility of the content may be improved in the second state 602. In addition, by displaying the background area 661 and 662 in the second state 602, the unity between the first content 651 and the second content 652 having different forms may be increased.

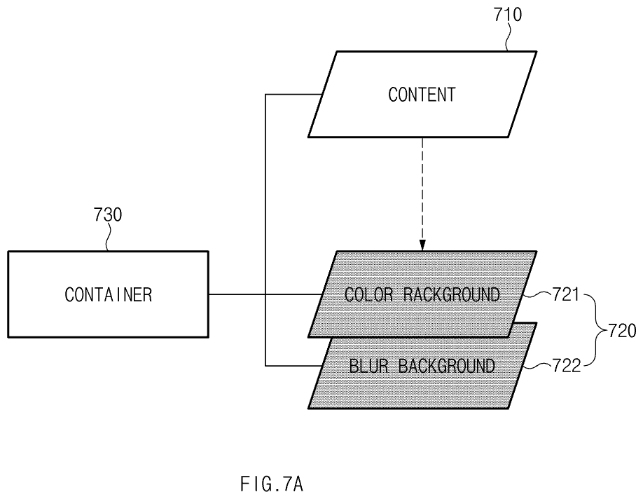

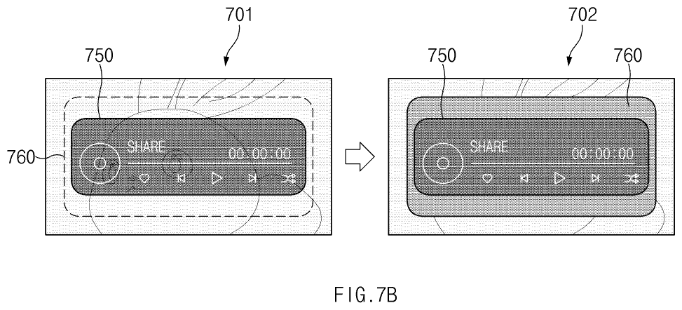

FIG. 7A illustrates layer combining of a content in the second section according to an embodiment.

FIG. 7B is an example diagram illustrating display of a background image in the second section according to an embodiment.

Referring to FIGS. 1 and 7A, the processor 120 may extract a dominant color from the content area or the dominant color extraction area. The processor 120 may check an alpha value indicating the transparency of the dominant color. The processor 120 may compare the alpha value of the dominant color with a plurality of reference values. For example, when the alpha value of the dominant color is greater than a first value (e.g., alpha value of 26) and less than or equal to a second value (e.g., alpha value of 229), the processor 120 may determine the dominant color as the second section. For example, the second section may be determined as a semi-transparent section.

According to an embodiment, in the second section, the processor 120 may determine a background image by combining a color image (or an opaque image) 721 and a blur image 722. The processor 120 may combine a content layer 710 containing data of the content and a background layer 720 and store them in a container 730. The background layer 720 may include a color image 721 and a blur image 722. The container 730 may be a buffer that stores output data related to the content. The output data stored in the container 730 may be additionally overlapped on the background image of the home screen and then displayed.

Referring to FIGS. 1 and 7B, the processor 120 may display a content 750 on the display. The processor 120 may display the content 750 by automatic setting of the electronic device or by a user input. The processor 120 may set a background area 760 corresponding to the content 750.

For example, the content 750 may be a widget of a music application. When the content 750 has a grid size of 4×2, the background area 760 may be the same as a grid area of 4×2 or may be a partially reduced area of the grid area of 4×2. The background area 760 may be an area that is enlarged compared to the area occupied by the content 750.

In the content 750, text or a button may be primarily white, whereas the remaining area is semi-transparent (e.g., semi-transparent gray). In this case, a semi-transparent color (e.g., semi-transparent gray) is determined as the dominant color, and the transparency of the dominant color may be determined as the second section. The processor 120 may combine and display a color image (e.g., a gray image) based on the dominant color and a blur image in the background area 760.

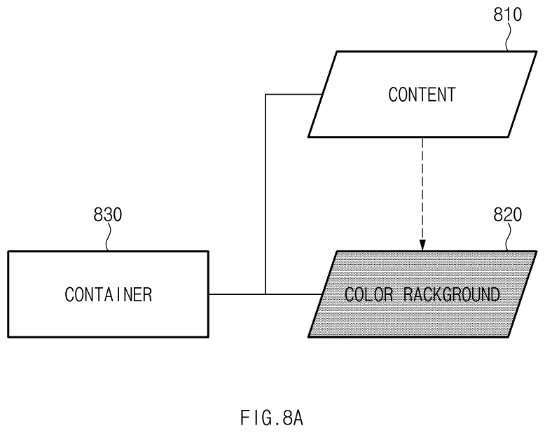

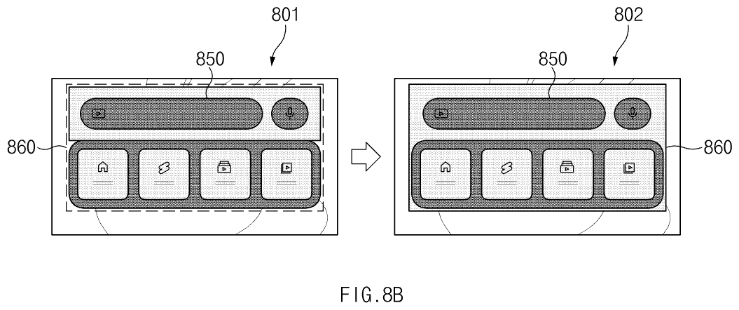

FIG. 8A illustrates layer combining of a content in the third section according to an embodiment.

FIG. 8B is an example diagram illustrating display of a background image in the third section according to an embodiment.

Referring to FIGS. 1 and 8A, the processor 120 may extract a dominant color from the content area or the dominant color extraction area. The processor 120 may check an alpha value indicating the transparency of the dominant color. The processor 120 may compare the alpha value of the dominant color with a plurality of reference values. For example, when the alpha value of the dominant color exceeds a second value (e.g., alpha value of 229), the processor 120 may determine the dominant color as the third section. For example, the third section may be determined as an opaque section.

According to an embodiment, in the third section, the processor 120 may determine a color image (or an opaque image) 820 as the background image. The processor 120 may combine a content layer 810 containing data of the content and a background layer 820 and store them in a container 830. The container 830 may be a buffer that stores output data related to the content. The output data stored in the container 830 may be additionally overlapped on the background image of the home screen and then displayed.

Referring to FIGS. 1 and 8B, the processor 120 may display a content 850 on the display. The content 850 may be displayed by automatic settings of the electronic device or by a user input. The processor 120 may set a background area 860 corresponding to the content 850.

For example, the content 850 may be a widget of a video application. When the content 850 has a grid size of 4×2, the background area 860 may be the same as a grid area of 4×2 or may be a partially reduced area of the grid area of 4×2. The background area 860 may be an area that is enlarged compared to the area occupied by the content 850.

The content 850 may have a main area that is opaque (e.g., light gray). In this case, an opaque color (e.g., light gray) is determined as the dominant color, and the transparency of the dominant color may be determined as the third section. The processor 120 may display a color image (e.g., a gray image) based on a dominant color in the background area 860.

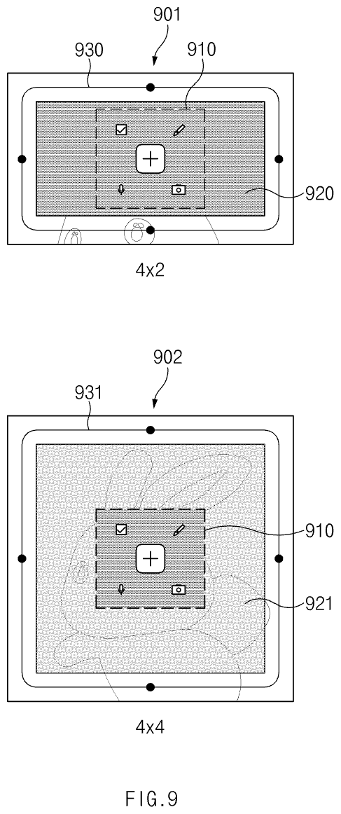

FIG. 9 illustrates a change in a background area according to a change in a content allocation area according to an embodiment. FIG. 9 is an example and embodiments are not limited thereto.

Referring to FIG. 9, when a change in content occurs, the processor 120 may reset the background area in response to the change in content. According to an embodiment, the processor 120 may dynamically change the background area when the size of a displayed content 910 changes (when the content allocation area changes). For example, the content 910 may change the size based on factors such as updates, resizes, theme changes, or changes in portrait/landscape mode.

According to an embodiment, in a first state 901, a content allocation area 930 of the content 910 may be determined as an area smaller than or equal to a grid area of 4×2.

According to an embodiment, in the first state 901, a background area 920 may be determined as an area that includes the content 910 and is smaller than the content allocation area 930. The processor 120 may determine a dominant color as an opaque color (e.g., gray) in a dominant color extraction area including the content 910. Since the proportion of the content area in the dominant color extraction area is high, the color of the content 910 is mainly reflected, so that the dominant color may be determined. The processor 120 may display an opaque image in the background area 920.

According to an embodiment, in a second state 902, the content allocation area 930 of the content 910 may be determined as an area smaller than or equal to the grid area of 4×2.

In the second state 902, a background area 921 may be determined as an area that includes the content 910 and is smaller than a content allocation area 931. In the second state 902, the dominant color extraction area may be extended more than in the first state 901. In this case, the ratio of the content area to the dominant color extraction area may be reduced, and a transparent color may be determined as the dominant color. The processor 120 may display a blur image or a semi-transparent image in the background area 921.

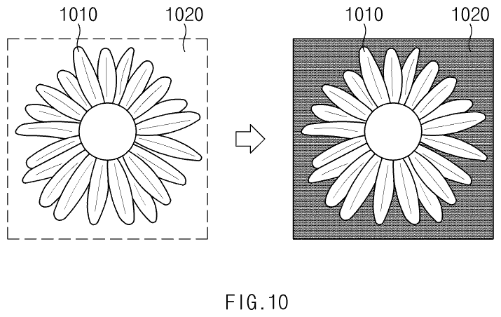

FIG. 10 is an example diagram illustrating an inverted background image according to an embodiment. FIG. 10 is an example and embodiments are not limited thereto.

Referring to FIGS. 1 and 10, the processor 120 may display a content 1010 on the display. For example, the content 1010 may be an image obtained by removing a background image and extracting only a specific object through an object extraction function in an image editing application.

The processor 120 may determine a background area 1020 by reflecting the size of the content 1010. For example, the background area 1020 may be a smallest square area that includes the entire content 1010. Then, the processor 120 may determine a dominant color in the background area 1020. When an object is primarily white, with the rest of the area being transparent, white may be determined as the dominant color.

The processor 120 may generate a background image with the dominant color inverted and display it in the background area 1020. In this way, the visibility of the content 1010 may be increased. The inversion of the dominant color may include changing a color from white to black or from black to white.

According to an embodiment, the processor 120 may display a user interface that provides an option as to whether to allow a dynamic change of the background area for each content. When the change of the background area is disabled by the user input, the processor 120 may not apply the dynamic change process for the background area.

According to an embodiment, the processor 120 may change a dynamic change method for the background area by reflecting surrounding illuminance. For example, the processor 120 may change the background image to increase the visibility of the content by measuring the surrounding illuminance after the background image is determined based on the transparency of the dominant color.

According to an embodiment, the processor 120 may differently set the dynamic change method for the background area depending on the manufacturer of the application. For example, when dominant color information or background area information on a widget of an application of a given manufacturer is stored in advance, a process of extracting a separate dominant color may not be performed.

According to an embodiment, the processor 120 may dynamically change the background area of the content in various electronic devices 101. For example, the electronic device 101 may be a smartphone, a tablet, a desktop, or a virtual studio technology (VST) device.

According to an embodiment, the processor 120 may determine the dominant color of the content or the background image by utilizing artificial intelligence (AI) and machine learning (ML). By learning from large data sets using artificial intelligence (AI) and machine learning (ML) algorithms, it is possible to identify various conditions and the color and transparency of the content, and dynamically change the background based on them. For example, in a streaming state of a particular movie, multiple backgrounds may be dynamically changed by reflecting the dominant color and transparency of a currently playing content by incorporating current user surroundings (e.g., night/day).

Electronic devices may fill empty margins in the digital content with a background using 1) the semi-transparent background, 2) the blur background, or 3) the dominant color background. In this case, there is a problem that an appropriate background is not applied depending on the characteristics of the content, and the background area is different for each content, making it difficult to provide a consistent screen.

According to an aspect of the disclosure, an electronic device, includes: a display; a memory; and at least one processor comprising a processing circuit, in which the memory stores instructions that, when executed by the at least one processor individually or collectively, cause the electronic device to: determine a content to be displayed on the display and a first area allocated to the content, determine a second area included in the first area, determine a dominant color in a fourth area including a third area corresponding to the content, determine an amount of transparency of the dominant color, determine a section including the amount of transparency among a plurality of sections distinguished by a plurality of reference values related to the amount of transparency, determine a background image to be applied to the second area according to the determined section, combine and display the content and the background image on the display.

The plurality of reference values include a first reference value and a second reference value indicating an amount of transparency lower than the first reference value.

The instructions, when executed by the at least one processor individually or collectively, cause the electronic device to determine a blur image as the background image based on determining the amount of transparency of the dominant color is lower than or equal to the first reference value.

The instructions, when executed by the at least one processor individually or collectively, cause the electronic device to combine, based on determining that the amount of transparency of the dominant color exceeds the first reference value and is lower than or equal to the second reference value, an image having the dominant color with a blur image to determine the background image.

The instructions, when executed by the at least one processor individually or collectively, cause the electronic device to, based on determining that the amount of transparency of the dominant color exceeds the second reference value, determine an image having the dominant color as the background image.

The instructions, when executed by the at least one processor individually or collectively, cause the electronic device to: generate a bitmap image corresponding to the fourth area; extract a histogram of colors from the bitmap image; and determine the dominant color based on a frequency of colors appearing in the histogram.

The instructions, when executed by the at least one processor individually or collectively, cause the electronic device to determine a color from the frequency of colors with a highest frequency in the histogram as the dominant color.

The instructions, when executed by the at least one processor individually or collectively, cause the electronic device to, based on determining a first color with a first highest frequency in the histogram is transparent, determine a second color with a second highest frequency as the dominant color.

The instructions, when executed by the at least one processor individually or collectively, cause the electronic device to, based on determining a first color from the frequency of colors with a highest frequency in the histogram is transparent, apply a preset weight to a second color with the second highest frequency.

The fourth area is the same as the second area.

The fourth area is the same as the third area.

The fourth area is smaller than the second area and includes the third area.

The instructions, when executed by the at least one processor individually or collectively, cause the electronic device to set a grid area corresponding to the content as the first area on the display.

The content is an icon or a widget of a digital object or an application displayed on the display.

The plurality of reference values are set by reflecting an alpha value set for the dominant color.

According to an aspect of the disclosure, a method for displaying a content performed on an electronic device, including determining the content to be displayed on a display of the electronic device and a first area allocated to the content; determining a second area corresponding to the first area; determining a dominant color in a fourth area including a third area corresponding to the content; determining an amount of transparency of the dominant color; determining a section including the amount of transparency among a plurality of sections distinguished by a plurality of reference values related to the amount of transparency; determining a background image to be applied to the second area according to the determined section; and combining and displaying the content and the background image on the display.

The plurality of reference values include a first reference value and a second reference value indicating an amount of transparency lower than the first reference value.

The combining and displaying of the content and the background image further comprises determining a blur image as the background image based on determining the amount of transparency of the dominant color is lower than or equal to the first reference value.

The combining and displaying of the content and the background image further comprises combining, based on determining that the amount of transparency of the dominant color exceeds the first reference value and is lower than or equal to the second reference value, an image having the dominant color with a blur image to determine the background image.

The combining and displaying of the content and the background image further comprises, based on determining that the amount of transparency of the dominant color exceeds the second reference value, determining an image having the dominant color as the background image.

According to an aspect of the disclosure, a non-transitory computer readable medium having instructions stored therein, which when executed by a processor cause the processor to execute a method for displaying a content performed on an electronic device, including determining the content to be displayed on a display of the electronic device and a first area allocated to the content; determining a second area corresponding to the first area; determining a dominant color in a fourth area including a third area corresponding to the content; determining an amount of transparency of the dominant color; determining a section including the amount of transparency among a plurality of sections distinguished by a plurality of reference values related to the amount of transparency; determining a background image to be applied to the second area according to the determined section; and combining and displaying the content and the background image on the display.

An electronic device according to an embodiment disclosed herein may extract the dominant color of the content (e.g., through histogram analysis) and then determine the background of the content in a differentiated manner according to the transparency of the dominant color. In this way, the electronic devices may set a natural background for a different content. When the background image in which the transparency of the dominant color is reflected is displayed in the background area, the visibility of the content may be improved. In addition, by setting the background area corresponding to the size of the widget to be consistent, the home screen may be displayed more consistently.

An electronic device according to an embodiment disclosed herein may provide a background area capable of increasing user visibility depending on the content, with an appropriate size depending on the disposition of the content. In this way, the electronic device may provide a screen having an aligned visual design.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
memory storing instructions; and
at least one processor comprising a processing circuit,
wherein the instructions, when executed by the at least one processor individually or collectively, cause the electronic device to:
determine a content to be displayed on the display and a first area allocated to the content,
determine a second area included in the first area,
determine a dominant color in a fourth area including a third area corresponding to the content,
determine an amount of transparency of the dominant color,
determine a section including the amount of transparency among a plurality of sections distinguished by a plurality of reference values related to the amount of transparency,
determine a background image to be applied to the second area based on the determined section, and
combine the content and the background image and display the combined content and background image on the display.

2. The electronic device of claim 1, wherein the plurality of reference values include a first reference value indicating a first amount of transparency and a second reference value indicating a second amount of transparency that is lower than the first amount of transparency.

3. The electronic device of claim 2, wherein the instructions, when executed by the at least one processor individually or collectively, cause the electronic device to, based on determining the amount of transparency of the dominant color is lower than or equal to the first reference value, determine a blur image as the background image.

4. The electronic device of claim 2, wherein the instructions, when executed by the at least one processor individually or collectively, cause the electronic device to combine, based on determining that the amount of transparency of the dominant color is greater than the first reference value and less than or equal to the second reference value, an image having the dominant color with a blur image to determine the background image.

5. The electronic device of claim 2, wherein the instructions, when executed by the at least one processor individually or collectively, cause the electronic device to, based on determining that the amount of transparency of the dominant color is greater than the second reference value, determine an image having the dominant color as the background image.

6. The electronic device of claim 1, wherein the instructions, when executed by the at least one processor individually or collectively, cause the electronic device to:
generate a bitmap image corresponding to the fourth area;
extract a histogram of colors from the bitmap image; and
determine the dominant color based on a frequency of colors appearing in the histogram.

7. The electronic device of claim 6, wherein the instructions, when executed by the at least one processor individually or collectively, cause the electronic device to determine a color from the frequency of colors with a highest frequency in the histogram as the dominant color.

8. The electronic device of claim 6, wherein the instructions, when executed by the at least one processor individually or collectively, cause the electronic device to, based on determining a first color with a first highest frequency in the histogram is transparent, determine a second color with a second highest frequency as the dominant color.

9. The electronic device of claim 6, wherein the instructions, when executed by the at least one processor individually or collectively, cause the electronic device to, based on determining a first color from the frequency of colors with a highest frequency in the histogram is transparent, apply a preset weight to a second color with a second highest frequency.

10. The electronic device of claim 1, wherein the fourth area is the same as the second area.

11. The electronic device of claim 1, wherein the fourth area is the same as the third area.

12. The electronic device of claim 1, wherein the fourth area is smaller than the second area and includes the third area.

13. The electronic device of claim 1, wherein the instructions, when executed by the at least one processor individually or collectively, cause the electronic device to set a grid area corresponding to the content as the first area on the display.

14. The electronic device of claim 1, wherein the content is an icon or a widget of a digital object or an application displayed on the display.

15. The electronic device of claim 1, wherein the plurality of reference values are set by reflecting an alpha value set for the dominant color.

16. A method for displaying a content performed on an electronic device, the method comprising:
determining the content to be displayed on a display of the electronic device and a first area allocated to the content;
determining a second area included in the first area;
determining a dominant color in a fourth area including a third area corresponding to the content;
determining an amount of transparency of the dominant color;
determining a section including the amount of transparency among a plurality of sections distinguished by a plurality of reference values related to the amount of transparency;
determining a background image to be applied to the second area based on the determined section; and
combining the content and the background image and displaying the combined content and background image on the display.

17. The method of claim 16, wherein the plurality of reference values include a first reference value indicating a first amount of transparency and a second reference value indicating a second amount of transparency that is lower than the first amount of transparency.

18. The method of claim 17, wherein the combining the content and the background image comprises determining a blur image as the background image based on determining the amount of transparency of the dominant color is lower than or equal to the first reference value.

19. The method of claim 17, wherein the combining the content and the background image further comprises, based on determining that the amount of transparency of the dominant color exceeds the first reference value and is lower than or equal to the second reference value, combining an image having the dominant color with a blur image to determine the background image.

20. The method of claim 17, wherein the combining the content and the background image further comprises, based on determining that the amount of transparency of the dominant color exceeds the second reference value, determining an image having the dominant color as the background image.
